(19) United States
(12) Patent Application Publication
(10) Pub. No.: US 2012/0234863 A1
(43) Pub. Date: Sep. 20, 2012

(54) SPRAYING DEVICE WITH AUTOMATICALLY ACTUATED SHUTTER

(76) Inventor: Pia Kahler, Straubenhardt (DE)

(21) Appl. No.: 13/510,349

(22) PCT Filed: Nov. 20, 2009
(86) PCT No.: PCT/EP09/65570

§ 371 Date: Jun. 6, 2012

(51) Int. Cl. B05B 11/00; B67D 7/06

(52) U.S. Cl. 222/182; 222/321.9; 222/321.8; 222/183

(57) ABSTRACT

A spraying device for spraying messenger, insecticide, fragrance, body care, hygienic liquids or the like, comprises a liquid container (10), an actuating member (20) which actuates a pump mechanism (30) to order to feed a liquid from the liquid container to a spraying aperture (40), wherein the spraying aperture is formed in the actuating member, and a cover member (50) capable of covering the spraying aperture. Said cover member (50) is operationally connected to the actuating member (20) such that, upon actuation of said actuating member, the cover member (50) is translatorially displacable from its position covering the spraying aperture (40) before the pump mechanism (30) is actuated.

### FIELD OF THE INVENTION

The present invention relates to a spraying device for spraying messenger, insecticide, fragrance, body care, hygienic liquids or the like.

### BACKGROUND OF THE INVENTION

Perfume atomizers are a well-known kind of spraying devices. A conventional perfume atomizer comprises a liquid container, a pump mechanism being threaded or press-fitted onto an upper side of said liquid container, and an actuating member. Said actuating member is generally formed in a button shape so as to be pushed by a finger. On a lateral side of the actuating member a spraying nozzle is arranged. Liquid out of the container is fed to the spraying nozzle via the pump mechanism.

In order to protect the actuating member from being actuated by mistake, a cover member is slipped over the actuating member or pump mechanism. This cover member is some kind of a cap which tightly fits over the outermost circumference of the respective member. When using the perfume atomizer, the cap has to be pulled off the spraying device and then the actuating member can be pushed to actuate the pump mechanism to spray a perfume or the like. Other atomizers come without any kind of covers. Various shapes of atomizers have been developed. Also different shapes are available which are ergonomic or have a smooth outside face.

However, with respect to spaying devices which have no cover members, the spraying nozzles are always exhibited to the environment. After some perfume or the like has been sprayed by the spraying nozzle, small amounts of liquid remain outside of the nozzle as a droplet. In case the user wants to return the spraying device back into a hand bag or a trouser pocket, the remaining droplet will undesirably get in contact therewith.

### SUMMARY OF THE INVENTION

The object of the present invention is to provide an improved spraying device. The spraying device according to the invention comprises the features of independent claim 1. Further advantageous developments are provided by the subject-matters of the dependent claims.

The spraying device for spraying messenger, insecticide, fragrance, body care, hygienic liquids or the like comprises a liquid container, an actuating member which actuates a pump mechanism in order to feed a liquid from the liquid container to a spraying aperture, wherein the spraying aperture is formed at the actuating member, and a cover member capable of covering the spraying aperture. Said cover member is operationally connected to the actuating member such that, upon actuation of the same, the cover member is translatorially displacable from its position covering the spraying aperture before the pump mechanism is actuated.

In this context “translatorially” means along a straight line or along a plurality of displacement paths arranged on after each other in contrast to a pure rotation. As the cover member is operationally connected to the actuating member and the actuating member is capable of actuating the pump mechanism, the spraying device can be set very fast into an operating state because, contrary to a conventional spraying device, the spraying device of the invention exhibits the spraying aperture and actuates the pump mechanism upon one single action. The translatorial displacement of the cover member can be achieved by an inexpensive arrangement. The cover member of the spraying device according to the invention provides that small amounts of liquid remaining outside the spraying aperture after a pump activity are not present at an outer face of the device because the cover member covers the spraying aperture.

The actuating member is capable of actuating the pump mechanism. The actuating member is connected to the pump mechanism via an arrangement which is able to retard the actuation of the pump mechanism. This retarded actuation of the pump mechanism allows a retraction operation of the cover member before the pump mechanism is actuated to pump liquid. This retraction operation is preferably executed within a first actuation step. Said retraction operation can be entirely or partially completed in the first actuation step.

The actuating member can form a first part of the casing and the liquid container can be formed within a second part of the casing. However, the liquid container itself can form the second casing part. The first part of the casing and the second part of the casing get closer to each other upon actuation of said actuating member. The first part of the casing and the second part of the casing are translatorially pushable towards each other upon actuation of said actuating member. This operating mode is intuitive for a user and can be performed easily and securely since there no pure rotation of a first part with respect to a second part is required.

Preferably, the actuating member forms a major part of the casing. “Major part” shall be understood such that an exterior face of the actuating member is bigger than a face occupied by a finger tip which pushes the actuating member. For example, the exterior face of the actuating member can be approximately one half of the entire surface of the spraying device. The liquid container itself or some kind of casing which covers the liquid container can form the second part of the entire casing. In an advantageous further development the two separate casing parts are configured such that they can slide relative to each other. Accordingly, one of the two casing parts is provided with a deepened portion to be inserted into the other casing part, for instance. This arrangement makes it easy for a user to handle the spraying device because the actuating member is not tiny.

The cover member is preferably configured that, in a non-actuated state of the actuating member, an external contour of an exterior face of the cover member substantially corresponds to an internal contour of an opening in an exterior face of the actuating member. This contour can have different shapes, e.g. circular, elliptical or polygonal. Therefore, the spraying device does not have any sharp edges which may hurt the user. Accordingly, the use of the spraying device according to the invention is pleasant. Moreover, the corresponding contours of the cover member and the actuating member achieve that the gaps between these parts are as small as possible. Therefore, no foreign matters are deposited. Hence, the spraying aperture is protected in the non-actuated state.

Preferably, a through hole is provided in the actuating member. The cover member is slidably guidable within the through hole of the actuating member. Therefore a secure movement of the cover member can be assured. In the non-actuated state of the actuating member the cover member can be positioned such that its exterior face fits in the opening of the through hole in the actuating member. The sectional shape of the through hole is arbitrary. It can be circular, elliptical or polygonal, for instance.

In a non-actuated state of the actuating member, it is advantageous if the exterior face of the cover member and the exterior face of the actuating member preferably form a flush face. In other words, the exterior face of the cover member and the exterior face of the actuating member complement each other such that a substantially continuous face develops. Tiny offsets at the transition from the one face of the actuating member to the other face of the cover member do in general not change the overall appearance. The same applies for small gaps between the two members which are necessary for allowing a sliding movement of the cover member within the through hole in the actuating member. Since no major gaps or steps are formed on the outside of the spraying device, no foreign matter cumulates.

The cover member can also be provided on an outside of the actuating member instead of being provided in a through hole. According to this, the cover member has to be guided and driven on a side of the cover member which faces the actuating member. This configuration also can be formed so as to generate a flush outer face. The cross sectional shape of the cover member in this configuration may be plate-shaped, bent or curved in order to form a flush face with the adjacent members. The entire dimensions of the spraying device can be formed more compact accordingly. The flush face provides that no dust or the like will adhere because there are no steps in the transition from the actuating member to the cover member.

The cover member is operationally connected to the actuating member. The operational connection can be formed by one or more gear members and a rack, for instance. The operational connection can also be realized by one or more pulleys and a wire. Preferably, a lever is pivotally provided within the spraying device which transforms a movement of the actuating member into a movement of the cover member. The lever is pivotally provided within the spraying device which transforms the translatorial pushing movement of the actuating member into the translatorial displacement movement of the cover member. Providing a lever is inexpensive and the technique is reliable and simple.

The lever can be pivotally provided at an upper support member of the actuating member, the lever having a first lever arm which contacts an outer contour of a lower support member provided at the liquid container and a second lever arm which contacts the cover member. However, the lever can also be pivotally provided at a lower support member of the liquid container, the lever having a first lever arm which contacts an outer contour of an upper support member of the actuating member and a second lever arm which contacts the cover member.

The specific lever has three contact points with the spraying device. A first contact point of the lever is a support which acts as a fulcrum around which the lever can rotate. A second contact point is at the cover member. A third contact point is either at the liquid container of the spraying device or at the actuating member or the upper and lower support members, respectively. The position of the fulcrum depends on said third contact point. In case the third contact point is at the liquid container side of the spraying device, the support point/fulcrum has to be at the actuating member. In case the third contact point is at the actuating member, the support point/fulcrum has to be at the liquid container side of the spraying device. The shape of the lever itself has to be adjusted to the respective configuration such that a movement of the actuating member is transformed into a movement of the cover member.

Preferably, the lever is pivotally provided on the actuating member or the corresponding upper support member of the actuating member, respectively. Accordingly, the lever has the first lever arm which contacts the lower support member of the liquid container and a second lever arm which contacts the cover member.

The lever can also be pivotally provided on the lower support member of the liquid container. Hence, the lever has the first lever arm being in contact with the actuating member and the second lever arm being in contact with the cover member. Hence, the lever is formed depending on the respective configuration.

The length of said first lever arm is preferably shorter than the length of said second lever arm. As a result, the cover member is moved faster than the actuating member upon actuation of the actuating member. Accordingly, the opening within the casing of the actuating member is opened at least to a great extent before the pump mechanism delivers liquid to the spraying aperture. Hence, the cover member does not protrude into the spraying mist having a substantial cone shape and starting at the spraying aperture. In other words, a moving speed of the cover member is higher than a moving speed of the actuating member when the actuating member is actuated. The leverage effect allows that a small initial movement of the actuating member causes the cover member to substantially exhibit the spraying aperture. Hence, the spraying device is very fast ready for spraying.

A speed of pushing the actuating member upon actuation of the actuating member can be transformable into a higher speed of displacing the cover member. A pushing direction of the actuating member can be substantially aligned with a displacement direction of the cover member. This allows a compact arrangement of the members.

The moving direction of the actuating member can be different from a moving direction of the cover member. It is possible that the moving direction of the cover member is perpendicular to the moving direction of the actuating member, for instance. Preferably, a moving direction of the actuating member is substantially the same as a moving direction of the cover member. The configuration of the lever depends on the mutual moving directions of the actuating member and the cover member.

In the non-actuated state, a clearance is provided between the actuating member or the upper support member of the actuating member and the pump mechanism. This clearance decreases during the first actuation step in which the cover member is removed from the spraying aperture. At the end of said first actuation step the clearance is disappeared and the actuating member or the upper support member of the actuating member and the pump mechanism are in contact with each other. This assures that the cover member is moved first before the pump mechanism is actuated.

A first urging means is provided between the actuating member or the upper support member of the actuating member and the pump mechanism. The first urging means pushes back the actuating member into an initial position. Preferably, the first urging means is formed by a first spring which is easy and inexpensive.

In order to assure that the cover member completely opens the opening in the actuating member so as to exhibit the spraying aperture the following can be provided. Said first spring can be provided between the actuating member and the pump mechanism. Upon actuation of the actuating member said first spring is compressed and at the same time the lever actuates the cover member. When the first spring is compressed at its maximum, the lever has moved the cover member to a position at which the opening in the actuating member is substantially completely open. Then, the actuation process proceeds from this first actuation step to a second actuation step. Upon further actuating the actuating member, the actuating member actuates the pump mechanism. The second actuation step refers to the pumping operation. Hence, it is assured that the opening is completely open before liquid is sprayed. In other words, the actuating member actuates the pump mechanism such that the spraying operation is executed after the cover member exhibits the spraying aperture.

The actuating member can move the fulcrum of the lever translatorially upon the first step of actuation of the actuating member, wherein the lever is rotated by a contact force at the first lever arm of the lever such that the second lever arm displaces the cover member before the actuating member or the upper support member of the actuating member contacts the pump mechanism.

In other words, a translatorial displacement movement of the cover member relative to the actuating member can be substantially finished before the actuating member or the upper support member of the actuating member contacts the pump mechanism. This assures that the opening of the actuating member through which the liquid shall be sprayed is open.

In order to fix the ends of the spring the actuating member can have a contoured interior shape. Accordingly, the actuating member itself can be form as a thin-walled member which is fixed to the upper support member. These two members can be connected by any known method. In the following the “actuating member” refers to a combination of the respective members. The combination of two separate members is advantageous. The outer actuating member can be made of a material which has good haptic properties or which can be coated well. The interior upper support member can be made of a material which has good forming properties, for instance.

It is preferred that such a spraying device is in general constructed as a portable device. The pump mechanism is positioned inside the spraying device at a side of the liquid container, preferably on the top side. The actuating member, the pump mechanism and the liquid container can be substantially aligned in sequence. However, these members can be arranged in a different manner. The pump mechanism is connected to the liquid container wherein a suction tube of the pump mechanism can be preferably inserted into the liquid container to gather liquid. The spraying aperture can be provided on an upper part of the pump mechanism.

Operation efficiency is enhanced if the nozzle-like spraying aperture sprays out the liquid substantially perpendicular to said line in which the actuating member, the pump mechanism and the liquid container are aligned.

In addition, the pump mechanism is preferably connected to a lower support member or the liquid container. The lower support member is used for supporting the spring. The lower support member and the liquid container can be formed integrally or can be connected by any known method. Accordingly, the first spring can be provided between the actuating member and the liquid container or their respective support members. In case the lower support member and the liquid container are formed integrally, the pump mechanism is fixed to the liquid container. The pump mechanism can be fixed to the liquid container for example via a separate fixing member. However, this can also be done by any kind of press-fitting, screwing or the like.

The position of the first spring can be varied. The first spring can be positioned in a central position between the actuating member/upper support member and the pump mechanism. Since these two member shall contact each other after the first actuation step, a recess is formed into which the first spring will be accommodated accordingly. The central position of the first spring provides a smooth mechanical operation. The first spring can also be arranged at an opposite side of the spraying aperture with respect to the upper part of the pump mechanism. This position provides a compact design of the spraying device in the lengthwise direction.

A second spring can be provided between the cover member and the liquid container side of the spraying device or between the cover member and the actuating member. The second spring urges the cover member back into a position in which the cover member closes the opening in the actuating member when a user of the spraying device releases the actuating member. This second spring can be provided between the cover member and either the liquid container (or the lower support member, respectively) or the actuating member (or the upper support member, respectively). In case the spring is provided between the cover member and the actuating member, the spring extends to a side of the actuating member which is close to the liquid container side. Hence, a corresponding sub-assembly operation is facilitated.

Accordingly, the first spring urges the actuating member away from the pump mechanism and the second spring urges the cover member away from the liquid container side of the spraying device into its position covering the spraying aperture.

The cover member preferably has a recess on a side facing the lever, wherein the lever engages with said recess to translatorially displace the cover member upon actuation of the actuating member. The cover member can also be provided with a through hole which is formed perpendicular to the longitudinal direction of the cover member. The lever can be in contact with this through hole to move the cover member.

Furthermore, it is possible that the cover member is positively driven by the lever. Accordingly, a second spring would not be required since the lever itself moves the cover member back into its position covering the spraying aperture.

The spraying aperture is preferably provided at an upper portion of the pump mechanism. In general, the pump mechanism has an elongated shape. The pump mechanism is provided with a suction means which draws liquid out of the liquid container into the pump mechanism. The pump mechanism further pumps the liquid to the upper end of the pump mechanism. The liquid flow path at the upper end redirects the upwardly supplied liquid to a lateral side of the spraying device. The spraying aperture is provided at the distal end of liquid flow path. The spraying aperture can be provided on the pump mechanism directly or as a separate member which is connectable to the pump mechanism. Regarding the operation of the spraying device, the spraying aperture does not move when the actuating member moves in the first step of actuation. It only moves in the second step of actuation which actuates the pump mechanism when the clearance between the actuating member and the pump mechanism is disappeared and both the actuating member and the pump mechanism contact each other.

The liquid in the liquid container can be stored at substantially atmospheric pressure. The pressure in the liquid container may vary to a small extent depending on the ambient temperature. The liquid to be filled into the liquid container can be messenger, insecticide, fragrance, body care, hygienic liquids, disinfecting agents, lubricants or the like.

The spraying device can be assembled in different ways. Preferably, there are two sub-assemblies. First sub-assembly is constituted by the liquid container, the lower support member and the pump mechanism which is interposed between the liquid container and the lower support member. The second sub-assembly is constituted by the upper support member, the second spring, the cover member and the lever.

Subsequently the two sub-assemblies are connected with each other wherein the first spring is interposed between the two sub-assemblies. These two sub-assemblies connected with each other represent the basic assembly. This basic assembly is already capable of actuating the cover member when the first sub-assembly and the second sub-assembly are compressed. Next, the actuating member is connected to the basic assembly. The way how these components are connected with each other can be various, for example a snap-fit connection or via a bolt or a screw. Preferably there are through holes in the upper support member and the actuating member into which a pin is inserted.

The liquid container itself can be a part of the casing of the spraying device or can be arranged inside a separate casing part which at least partially covers said liquid container. In order to provide a smooth exterior surface of the spraying device the liquid container may be covered by a casing part. Hence, a filling port of the liquid container will be covered such that it is not visible when the casing part covers the liquid container. The filling port can be closed by a cap, a plug, a screw or the like. Said cap can for example be provided with a valve which allows filling the container from exterior. However, the cap can also be configured without any valve. The filling of the liquid container may be performed with a funnel. The funnel can be used to direct the liquid to be filled into the liquid container. The liquid can be supplied to the funnel by pouring, spraying or the like. Accordingly, the liquid can be sprayed from its original container into the funnel in order to supply the liquid into the liquid container of the spraying device according to the present invention.

The cap or plug can be threadedly connected to the liquid container or via a press-fitting. In case a separate casing part is provided for the liquid container, it can be connected to the cap or to the liquid container by any known method.

The casing parts including the actuating member can be made of a variety of different materials, e.g. plastic, metal, glass or wood. The interior support members and the liquid container are preferably made of plastic.

The actuating member preferably has a U-shaped projecting land portion and the casing part covering the liquid container has a U-shaped setback which corresponds to the shape of the actuating member. With this specific shape the sliding support of the spraying device is enhanced. However, the contours of the corresponding curves of land portion and setback can be different.

### BRIEF DESCRIPTION OF THE DRAWINGS

FIG. 1 shows a longitudinal cross section view of a first embodiment of the spraying device according to the invention in a non-actuated state,

FIG. 2 shows a longitudinal cross section view of the first embodiment of the spraying device according to the invention in an actuated state,

FIG. 3 shows a longitudinal cross section view of a second embodiment of the spraying device according to the invention in a non-actuated state,

FIG. 4 shows another longitudinal cross section view of second embodiment of the spraying device according to the invention in an actuated state,

FIG. 5 shows still another longitudinal cross section view of second embodiment of the spraying device according to the invention,

FIG. 6 shows a schematic view of the members of the second embodiment of the spraying device according to the invention,

FIGS. 7A and 7B show a front and a side view of the second embodiment of the spraying device according to the invention.

### BEST MODES FOR CARRYING OUT THE INVENTION

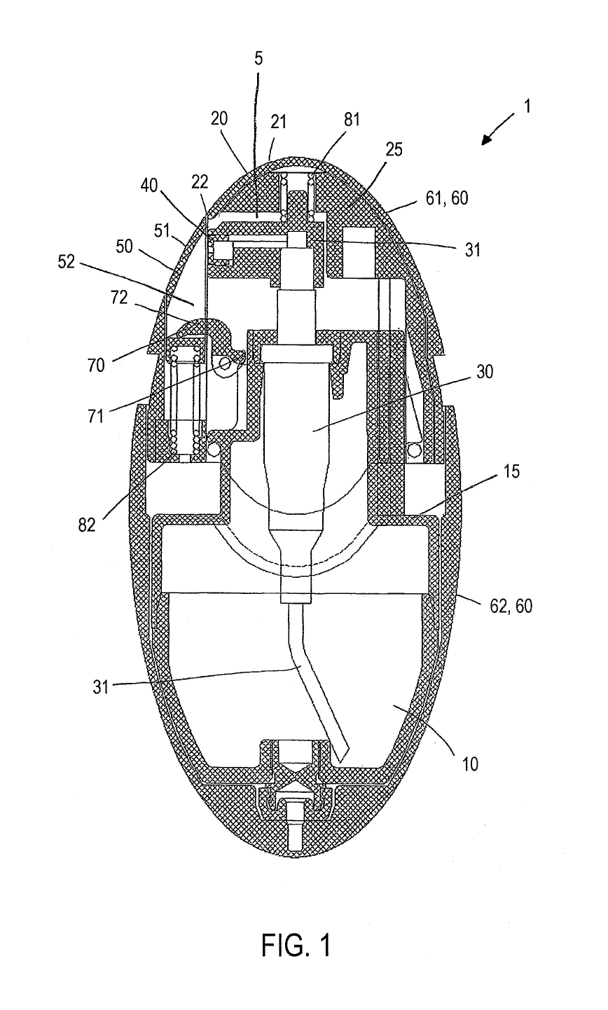

FIG. 1 shows a longitudinal cross section of a first embodiment of the spraying device of the present invention. In FIG. 1 the spraying device 1 is not actuated. A pump mechanism is arranged inside of the spraying device and comprises a suction tube 31 which reaches into a liquid container 10. The liquid container 10 is arranged in a lower portion of the spraying device shown in FIG. 1. The liquid container is made of plastic. The liquid container is transparent so that the amount of liquid inside the liquid container can be determined by a user when a casing part 62 is removed from the device.

The pump mechanism 30 is connected to the spraying device via a lower support member 15. A spraying aperture 40 is provided at an upper end of the pump mechanism 30. The spraying aperture 40 is arranged such that the liquid is sprayed sideways.

An actuating member 20 is arranged in an upper portion of the spraying device in FIG. 1. The actuating member is connected to the spraying device 1 via an upper support member 25. A spring 81 is provided between the actuating member 20 including the upper support member 25 and an upper part 31 of the pump mechanism 30. Said upper part is provided with the spraying aperture 40 and a protrusion on its top end. This protrusion serves as a support means for the first spring 81.

A second spring 82 is provided at the device. Said second spring 82 is provided between the upper support member 25 and a cover member 50. In FIG. 1, the first spring 81 urges the actuating member 20 upwards and away from the pump mechanism 30 and the second spring 82 urges the cover member 50 upwards and away from the upper support member 25.

A lever 70 is pivotally provided on the upper support member 25 of the actuating member 20. A first lever arm 71 contacts the lower support member 15 of the liquid container 10. A second lever arm 72 contacts an inner face of the cover member 50 and acts as a stopper for the cover member 50 when the cover member is in the non-actuated position. An external contour of an exterior face 51 of the cover member 50 substantially corresponds to an internal contour of an opening 22 in an exterior face 21 of the actuating member 20. Furthermore, the exterior face 51 of the cover member 50 and the exterior face 21 of the actuating member 20 form a flush face. In this non-actuated state the cover member 50 covers the spraying aperture 40.

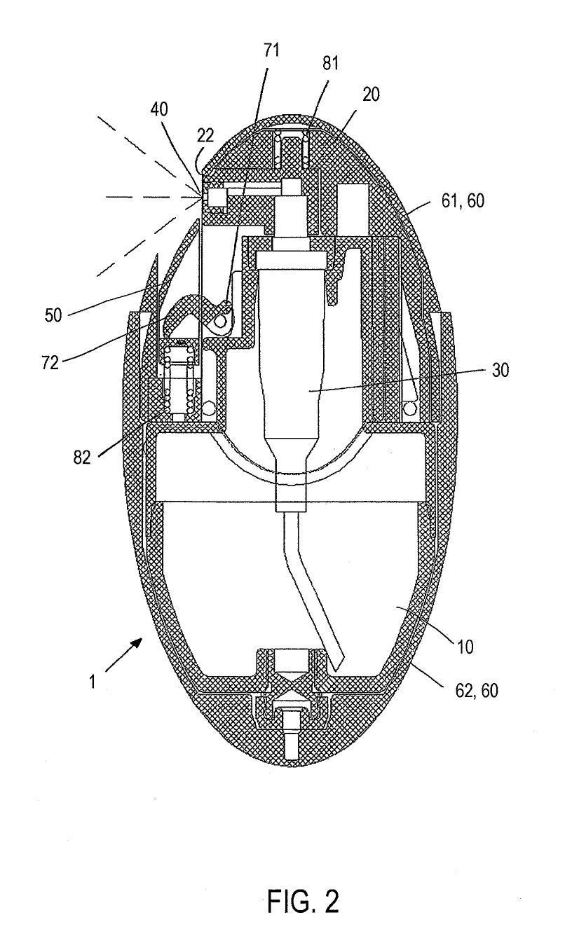

FIG. 2 shows a longitudinal cross section of the first embodiment of the spraying device of the present invention.

In FIG. 1 the spraying device 1 is actuated. In case a user pushes the upper end of the actuating member 20 and the lower end of the casing 62 of the liquid container 10 towards each other, the spraying device is actuated.

In FIG. 2 the spraying device is shown fully compressed. However, this actuation comprises two steps which are executed in series. In a first step, the actuating member is pushed and compresses the first spring 81 which is positioned in a central position over the pump mechanism. While the actuating member 20 compresses the first spring 81, the upper support member 25 being fixed with the actuating member 20 approaches to the pump mechanism 30 being fixed with the lower support member 15. As the lever 70 is has its fulcrum on the support member 25, this relative movement with respect to the other support member 15 rotates the lever 70 which moves the cover member 50. Since the first lever arm 71 is shorter than the second lever arm 72, the movement of the cover member 50 can be substantially finished at the end of the first step of the actuation. Subsequently, the cover member 50 is substantially completely retracted from the spraying aperture 40.

The second step of the actuation actuates the pump mechanism. The first spring is compressed at its maximum and the support member 25 is in contact with the pump mechanism. Further pushing of the actuating member 20 activates the pump mechanism.

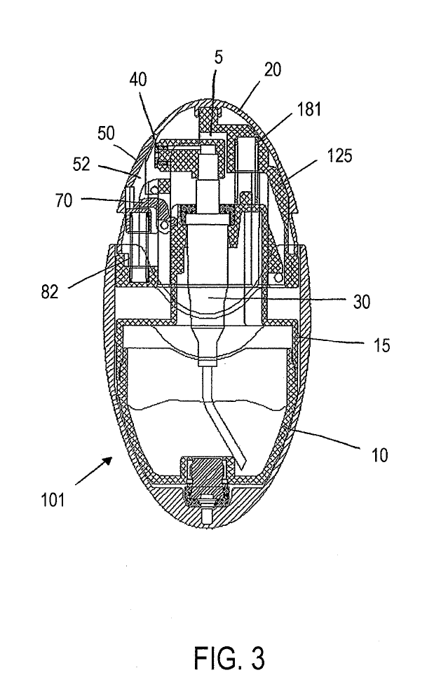

FIG. 3 shows a longitudinal cross section view of a second embodiment of the spraying device according to the invention. FIG. 3 shows a spraying device 101 in the non-actuated state. The reference numerals of members which are the same as in the first embodiment remain the same. The actuating member 20 is mounted on an upper support member 125. A first spring 181 is arranged between the upper support member 125 and the lower support member 15. The first spring is positioned beside the pump mechanism 30 (left side in FIG. 3) on an opposite side to the side at which the spraying aperture 40 is positioned. Accordingly, the spraying device 101 can be configured more compact than the spraying device 1 of the first embodiment. The lever 70 has the first and the second lever arms. Since the second lever arm 72 is longer than the first lever arm 71, the cover member 70 moves faster than the actuating member 20 and the support member 125. Hence, the cover member 70 is substantially retracted from the spraying aperture 40 before the pump mechanism 30 pumps liquid to the spraying aperture 40.

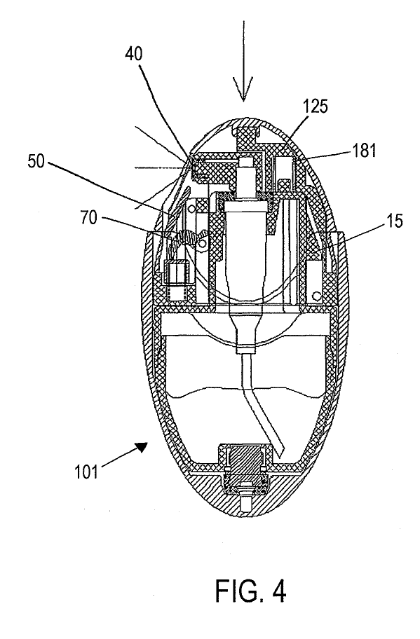

FIG. 4 shows another longitudinal cross section view of second embodiment of the spraying device 101 according to the invention in the actuated state. The spraying device is fully compressed. In other words, both the first step and the second step of the actuation are executed.

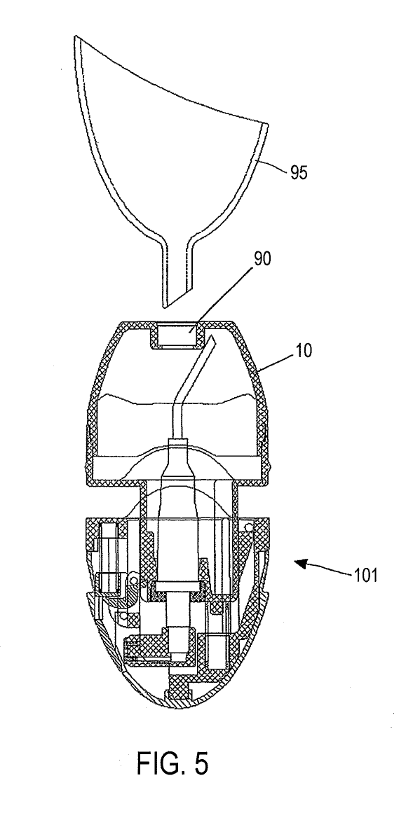

FIG. 5 shows still another longitudinal cross section view of the second embodiment of the spraying device according to the invention. In FIG. 5 the spraying device 101 is turned upside down. A filling port 90 of the liquid container 10 is opened for filling liquid therein. A funnel 95 can be inserted into the filling port 90 to ease a filling operation. The liquid to be filled into the liquid container can be messenger, insecticide, fragrance, body care, hygienic liquids, disinfecting agents, lubricant or the like.

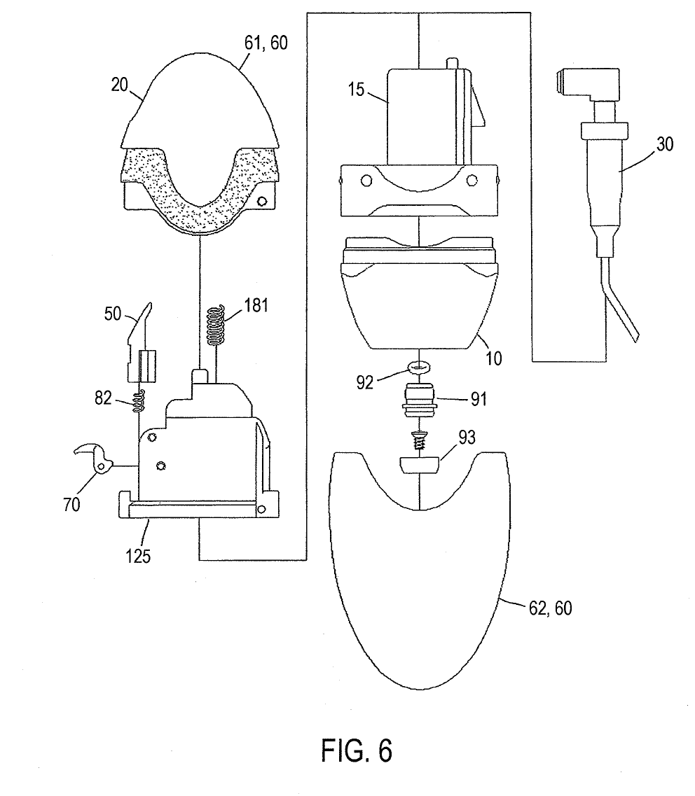

FIG. 6 shows a schematic view of the members of the second embodiment of the spraying device according to the invention. FIG. 6 shows how the different members of the spraying device 125 are assembled. There are two sub-assemblies. First sub-assembly is constituted by the liquid container 10, the lower support member 15 and the pump mechanism 30 which is interposed between the liquid container 10 and the support member 15. The second sub-assembly is constituted by the upper support member 125, the second spring 82, the cover member 50 and the lever 70.

Subsequently the two sub-assemblies are connected with each other wherein the first spring 181 is interposed between the two sub-assemblies. These two sub-assemblies connected with each other represent the basic assembly. This basic assembly is already capable of actuating the cover member when the first sub-assembly and the second sub-assembly are compressed. Next, the actuating member 20 is connected to the basic assembly.

The end of the liquid container which is on the opposite side of the actuating member is provided with a screw plug 91 and a sealing 92. The screw plug 91 is threadedly engagable with the liquid container 10. On its distal end the screw plug is provided with a circumferential protrusion. The casing part 62 which covers the liquid container 10 is provided with a rubber member 93 which is screwed to the casing part 62. The rubber member 93 has a circumferential recess at the inside which fits the circumferential protrusion of the screw plug 91. Accordingly, the casing part 62 can be detachably attached to the main assembly of the spraying device 101 by fitting the screw plug 91 into the rubber member 93.

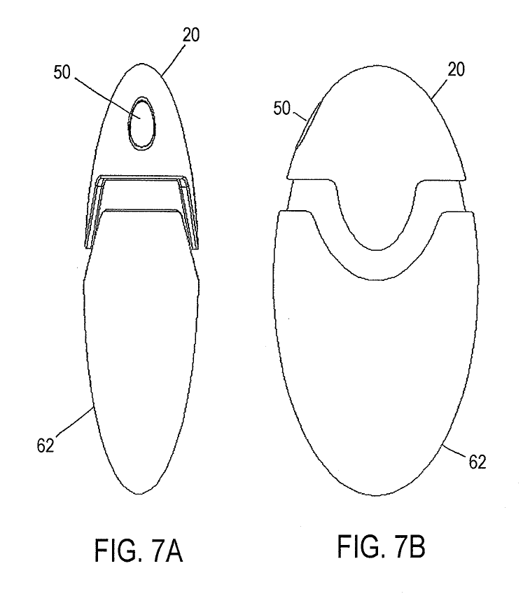

FIGS. 7A and 7B show a front view and a side view of spraying device according to the invention in a non-actuated state of the actuating member 20. The exterior face of the cover member 50 and the exterior face of the actuating member 20 form a flush face. Small gaps can be seen in FIG. 7A between the actuating member 20 and the cover member 50. Said gaps do not deteriorate the overall appearance of the spraying device as there are no major edges or jumps in the transition from the actuating member to the cover member. The side view in FIG. 7B shows the overall contour of the spraying device which is substantially continuous. A deepened portion is formed between the actuating member 20 and the casing part 62. This deepened portion slides into the casing part 62 upon actuation of the actuating member 20. In the side view, the actuating member 20 has a U-shaped land projection and the casing part 62 has a U-shaped setback which corresponds to the shape of the actuating member 20. With this specific shape the sliding support of the spraying device is enhanced.

1.-14. (canceled)

15. Spraying device for spraying messenger, insecticide, fragrance, body care, hygienic liquids or the like, comprising:
a liquid container which contains liquid at preferably atmospheric pressure;
a pump mechanism;
an actuating member which is translatorially pushable and which is capable to actuate the pump mechanism in order to feed a liquid from the liquid container to a spraying aperture, wherein the spraying aperture is formed in the actuating member; and
a cover member capable of covering the spraying aperture and being translatorially displacable from its position covering the spraying aperture upon actuation of said actuating member before the pump mechanism is actuated,
wherein via a lever, wherein the lever is pivotally provided within the spraying device which transforms a translatorial pushing movement of the actuating member into the translatorial displacement movement of the cover member.

16. Spraying device according to claim 15, wherein the actuating member forms a first part of the casing and the liquid container is formed within a second part of the casing and wherein the first part of the casing and the second part of the casing are translatorially pushable towards each other upon actuation of said actuating member.

17. Spraying device according to claim 15, wherein, in a non-actuated state of the actuating member, an external contour of an exterior face of the cover member substantially corresponds to an internal contour of an opening in an exterior face of the actuating member.

18. Spraying device according to claim 15, wherein, in a non-actuated state of the actuating member, an exterior face of the cover member and an exterior face of the actuating member form a flush face, preferably the actuating member and the cover member form a substantially continuous exterior shape in the non-actuated state.

19. Spraying device according to claim 15, wherein a first spring is provided between the actuating member or an upper support member of the actuating member and the pump mechanism which urges the actuating member away from the pump mechanism and wherein preferably a second spring is provided between the cover member and the actuating member which urges the cover member away from the actuating member into its position covering the spraying aperture.

20. Spraying device according to claim 15,
wherein the lever is pivotally provided at an upper support member of the actuating member, the lever having a first lever arm which contacts an outer contour of a lower support member provided at the liquid container and a second lever arm which contacts the cover member, or
wherein the lever is pivotally provided at a lower support member of the liquid container, the lever having a first lever arm which contacts an outer contour of an upper support member of the actuating member and a second lever arm which contacts the cover member.

21. Spraying device according to claim 19, wherein, in the non-actuated state, a clearance is provided between the actuating member or the upper support member of the actuating member and the pump mechanism.

22. Spraying device according to claim 20, wherein the cover member has a recess on a side facing the lever, wherein the lever engages with said recess to translatorially displace the cover member upon actuation of the actuating member.

23. Spraying device according to claim 20, wherein the length of said first lever arm is shorter than the length of said second lever arm.

24. Spraying device according to claim 19, wherein a speed of pushing the actuating member upon actuation of the actuating member is transed into a higher speed of displacing the cover member by the lever.

25. Spraying device according to claim 16, wherein a pushing direction of the actuating member is substantially aligned with a displacement direction of the cover member.

26. Spraying device according to claim 20, wherein the actuating member moves a fulcrum of the lever translatorially upon a first step of actuation of the actuating member, wherein the lever is rotated by a contact force at the first lever arm of the lever in said first step of actuation of the actuating member such that the second lever arm displaces the cover member before the actuating member or an upper support member of the actuating member contacts the pump mechanism.

27. Spraying device according to claim 26, wherein a translatorial displacement movement of the cover member relative to the actuating member is substantially finished before the actuating member or an upper support member of the actuating member contacts the pump mechanism.
